(19) United States
(12) Patent Application Publication
(10) Pub. No.: US 2011/0255996 A1
(43) Pub. Date: Oct. 20, 2011

(54) INVERTED FLUID DISPENSING PUMP AND DISPENSING SYSTEM, AND METHOD OF USING AN INVERTED PUMP

(76) Inventors: JAMES WICKSTEAD, Mendham, NJ (US); MICHAEL H. BARNETT, New York, NY (US); COLEMAN L. MUNCH, Lafayette, CA (US); MITCHELL A. ADLER, Irvington, NY (US)

(21) Appl. No.: 13/090,047

(22) Filed: Apr. 19, 2011

Related U.S. Application Data
(60) Provisional application No. 61/342,850, filed on Apr. 20, 2010.

(51) Int. Cl. F04B 49/22; F04B 49/06; F16K 31/06

(52) U.S. Cl. 417/53; 251/129.15; 137/565.01

(57) ABSTRACT

A valve system for controlling a flow of a fluid is provided that includes a port including a valve seat, and a ball adapted to cooperate with the valve seat to seal the port. The valve system also includes an arrangement for magnetically positioning the ball on the valve seat. A method for operating a pump is provided that includes releasing a piston causing the piston to return to an unactuated position to increase the interior volume forcing fluid in a reservoir to move into the piston body through a port due to a pressure differential between the interior volume and the reservoir. The method also includes sealing the port with a ball after the piston returns to an unactuated position and the pressure differential falls below a threshold by magnetically attracting the ball to a valve seat of the port.

### CROSS-REFERENCE TO RELATED APPLICATIONS

This application claims the benefit of U.S. Provisional Application No. 61/342,850 filed Apr. 20, 2010, which is incorporated herein by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to valves, and in particular relates to a valve operable under a variety of conditions, including inverted.

2. Background of the Invention

Conventional mechanical fluid dispersing pumps are used in a variety of applications from hand soaps to spray liquids. They are manufactured by numerous companies in a wide array of sizes, outputs and qualities. A similar design is used in many of these pumps, with the dispensing system located above the liquid reservoir. The conventional mechanical dispensing pump incorporates an intake port located at the bottom of the pump. A connecting tube leads from the outside of the intake port to the bottom of the liquid reservoir. The inside of the intake port leads to a pumping chamber which holds liquid to be dispersed. A piston is attached to a hollow activation nozzle and moves inside the pumping chamber.

When the activation nozzle is depressed, the piston is pressed into the pumping chamber causing any liquid in the chamber to be dispersed through the hollow activation nozzle. A coil spring is located inside the piston. A plastic or stainless steel ball valve is loosely located between the end of the spring and the intake port. When the activation nozzle is pressed inward, the spring is compressed keeping the ball valve in position. Because the ball is sitting on top of the intake port, the intake port is sealed so the liquid in the pumping chamber cannot escape. The compressed liquid is forced out the hollow activation nozzle.

When the activation is relaxed or released, the spring forces the piston open causing a vacuum in the pumping chamber. When the piston is fully open, the spring is relaxed and the ball valve opens allowing liquid into the pumping chamber. When the chamber is full, the ball valve settles (by gravity) on the intake port sealing it so no liquid escapes.

This conventional pump works as long as the product is oriented with the inlet port facing downward. However, when moved off the vertical or inverted, gravity causes the ball valve to fall away from the intake port, causing it to open.

In this new orientation, the liquid reservoir is now located above the pump and, with the intake port open, the weight of the liquid causes it to flow through the pumping chamber and out the hollow activation nozzle. In addition, the pump will no longer dispense fluid since the valve no longer functions. Leakage may also occur which drips from the hollow activation nozzle.

There are instances where it is advantageous to have a fluid dispersing pump situated in an inverted position, i.e. with the liquid reservoir located at the top and the fluid dispensing pump at the bottom. Fluid dispensing pumps such as this are used in a variety of applications, for example wall mounted pumps that dispense liquid hand soap. In this application, the soap is dispensed downward with the liquid reservoir being located above the pump. The pump is activated by a hand drive means, or by an electric motor. Peristaltic or gear drives may be used to dispense soap in an inverted position. In some cases, these can leak, which can be both unsightly and dangerous. Soap is slippery and if dripped on to a floor can become a hazard.

U.S. Pat. No. 7,389,893 discusses a fluid dispensing system that includes a pump body configured to couple to a container. The pump body defines fluid inlet openings and a pump cavity. A shroud cover covers the pump body to draw fluid from the container. An inlet valve allows fluid from the container to enter the pump cavity through the fluid inlet openings. A plunger is slidably received in the pump cavity, and the plunger defines a fluid passage with a dispensing opening through which the fluid is dispensed. A shipping seal seals the fluid passage during shipping to minimize leakage of the fluid during shipping. An outlet valve is disposed inside the fluid passage to minimize the height of the fluid between the outlet valve and the dispensing opening so as to minimize dripping of fluid from the dispensing opening. The pump body includes a venting structure to normalize the air pressure inside the system. However, the design disclosed therein is complex and costly, and requires a substantial investment in tooling.

U.S. Pat. No. 7,325,704 discusses a fluid dispensing system including a pump for pumping fluid from a container. The pump has a vent opening for venting air into the fluid in the container to normalize pressure inside the container as the fluid is pumped. An intake shroud is coupled to the pump, and the shroud includes a channel opening to draw fluid from the container into the pump in a straw-like manner. A baffle is positioned between the vent opening and the channel opening of the shroud to reduce ingestion of the air into the pump so as to reduce short or inconsistent dosing of the fluid when pumped.

U.S. Pat. No. 5,192,007 discusses a valve assembly which may be incorporated in a pump and container arrangement so as to permit the dispensing of liquid from the container when the container is in an inverted position as well as when the container is in its normal upright position. The valve assembly is primarily formed by a disc which has formed as part thereof a valve unit. The valve unit, in turn, is provided with a vent passage therethrough which is normally closed in the inverted position of the unit and a liquid passage which is normally closed in the upright position of the valve assembly. The liquid passage is opened by the weight of the liquid within the container on the ball check valve thereof when the container is inverted.

### BRIEF SUMMARY OF THE INVENTION

In accordance with the present invention, an inverted dispensing pump is provided that operates for both liquid and foam dispensing when the dispensing system is attached to and located under the reservoir of liquid or foam.

The invention incorporates an intake port located at a top of the pump. In some embodiments, inside the intake port is a non-corrosive ferrous ball valve. The non-corrosive, ferrous ball valve is held in close proximity to the intake port by a mechanical retainer which has openings allowing soap or liquid to come in contact with the ball valve.

Outside the intake port is a magnet. The intake port leads to a pumping chamber which holds liquid to be dispersed. A piston is attached to a hollow activation nozzle and moves within the pumping chamber. The piston and hollow activation nozzle is activated by an external means such as an electronically driven mechanism that contacts the external surface of the hollow activation nozzle.

This movement of the piston causes any liquid in the chamber to be dispersed through the hollow activation nozzle. The ferrous ball valve is held firmly against the intake port by both the magnet and by hydraulic pressure preventing liquid from being dispensed back through the intake port. When the activating nozzle and piston are moved downward by the external means it creates a partial vacuum which overcomes the magnetic force causing the ferrous ball valve to disengage from the intake port thereby allowing liquid to flow into the pumping chamber. When the flow of liquid is reduced and hydraulic pressures are equalized, the magnet draws the ferrous ball valve back up to and seals the intake port seat, thereby preventing any flow-through and/or leakage.

The use of the magnetic ball valve or other configuration of magnetic valve may be adapted to other pump designs using a free floating check valve in the inlet and allow those pumps to be used in the inverted position.

A valve system for controlling a flow of a fluid is provided that includes a port including a valve seat, and a ball adapted to cooperate with the valve seat to seal the port. The valve system also includes an arrangement for magnetically positioning the ball on the valve seat.

In the valve system, the check valve may be a ball or other configuration and may include ferrous material, and the arrangement for magnetically positioning the ball or check valve on the valve seat may include a magnet arranged on a side of the port opposite the valve seat.

In the valve system, the ball may include magnetic material and the arrangement for magnetically positioning the ball on the valve seat may include ferrous material arranged on a side of the port opposite the valve seat.

In the valve system, the ball may include magnetic material and the arrangement for magnetically positioning the ball on the valve seat may include a magnet arranged on a side of the port opposite the valve seat. The magnetic material in the ball and the magnet may have opposite polarities.

In the valve system, the ball may include magnetic material and the arrangement for magnetically positioning the ball on the valve seat may include a magnet arranged on a same side of the port as the valve seat and the ball may be restricted to a zone between the magnet and the valve seat. The magnetic material in the ball and the magnet may have a same polarity.

In the valve system, the arrangement for magnetically positioning the ball on the valve seat may include an electromagnet selectively operable to attract the ball to the valve seat to seal the port when activated, or allow the ball to move away from the valve seat to unseal the port when deactivated.

The valve system may further include a piston body having the port on a first end and an outlet on a second end opposite the first end, and a piston housed in the piston body and having an actuator handle adapted to move the piston toward the first end. As the piston moves toward the first end, fluid in the piston body may be forced out the outlet by a pressure differential between an interior of the piston body and an exterior region around the outlet.

In the valve system, the ball may be restricted to a zone around the valve seat by one of a retaining cage and an end of a spring arranged in the piston body.

After the piston is moved toward the first end, and after a force applied to the actuator handle to move the piston toward the first end is removed, the piston may move toward the second end. A pressure differential between the fluid in the piston body and fluid in a reservoir situated on an opposite side of the port from the piston body may cause fluid to flow from the reservoir to the piston body, causing the ball to move away from the valve seat.

In the valve system, the piston may move toward the second end in response to gravity, a spring arranged inside the piston body, a spring arranged outside the piston body, a motor moving the piston body, a magnetic attraction between the piston and an element having a fixed position with respect to the piston body, and/or a magnetic repulsion between the piston and the element having a fixed position with respect to the piston body.

The valve system may include a fluid diverter arranged on an opposite side of the port from the piston body. The fluid diverter may cause fluid to flow from a selected position in the reservoir to the port.

A method for operating a pump is provided that includes actuating a piston to decrease an interior volume of a piston body forcing fluid in the piston body out an outlet by a first pressure differential between the interior volume and an exterior region around the outlet. The method also includes releasing the piston causing the piston to return to an unactuated position to increase the interior volume forcing fluid in a reservoir to move into the piston body through a port due to a second pressure differential between the interior volume and the reservoir. The method also includes sealing the port with a ball after the piston returns to an unactuated position and the second pressure differential falls below a threshold by magnetically attracting the ball to a valve seat of the port.

The method may further include restricting the ball to a zone around the valve seat by one of a retaining cage and an end of a spring arranged in the piston body.

In the method, the piston may return to an unactuated position after being released under an influence of one of a spring, gravity, a motor, a magnetic attraction, and a magnetic repulsion.

The method may further include providing a magnet on a side of the port opposite the valve seat. The ball may include ferrous material.

The method may further include providing a ferrous material on a side of the port opposite the valve seat. The ball may include a magnet material.

The method may further include providing a magnet on a side of the port opposite the valve seat. The ball may include a magnet material and the magnetic material in the ball and the magnet may have opposite polarities.

The method may further include providing a magnet on a side of the port opposite the valve seat and restricting the ball to a zone between the magnet and the valve seat. The ball may include a magnet material and the magnetic material in the ball and the magnet may have a same polarity.

The method may further include providing an electromagnet selectively operable to attract the ball to the valve seat to seal the port when activated and allow the ball to move away from the valve seat to unseal the port when deactivated.

The method may further include diverting fluid from a selected position in the reservoir to an opposite side of the port from the piston body.

A valve system for controlling a flow of a fluid is provided that includes a port, an arrangement for sealing the port, and an arrangement for magnetically attracting the sealing means to the port.

These objects and the detail of this invention will be apparent from the following description and accompanying drawings.

### BRIEF DESCRIPTION OF THE DRAWINGS

FIG. 1 is a cross-sectional view of a first exemplary embodiment of an invertable pump, in an unactuated, recharging state, and incorporating a spring return, according to the present invention;

FIG. 2 is a cross-sectional view of the first exemplary embodiment of the invertable pump shown in FIG. 1, in an actuated state, and incorporating a spring return according to the present invention;

FIG. 3 is a cross-sectional view of a second exemplary embodiment of an invertable pump, in an unactuated, recharging state, according to the present invention;

FIG. 4 is a cross-sectional view of the second exemplary embodiment of the invertable pump shown in FIG. 3, in an actuated state, according to the present invention; and

FIG. 5 is a cross-sectional view of a third exemplary embodiment of an invertable pump, in an unactuated, recharging state, and incorporating a fluid diverter, according to the present invention.

### DETAILED DESCRIPTION OF THE INVENTION

Conventional pumps use a free floating ball at the intake port as a check valve, which is controlled by gravity and hydraulic pressure. When there is no flow of liquid and reduced hydraulic pressure, the ball relies on gravity to settle onto the valve seat sealing the intake. However, when the pump is inverted, the intake is oriented above the pump and the valve seat is above the ball, and gravity causes the free floating ball to unseat from the intake port. This allows liquid to flow through the valve and leak out the spout. Also, when the pump is depressed, the ball will not always seat since the hydraulic pressure may force liquid past the ball and seat causing it to remain open. In this case, the pump will not dispense fluid since it has lost hydraulic pressure, and instead pushes the liquid in the pump chamber back out the inlet into the reservoir.

The pump according to the present invention may be used with an external means coupled to the hollow pump activation nozzle, which causes the nozzle to close and/or open. For instance, a motor may be used to activate the nozzle, or to close the nozzle after a manual activation. This external device may perform some or all of the function of an internal spring.

A liquid pick-up diverter may be located over the outside of the intake port and terminating near the screw cap attachment. The result is the ability to pick up liquid near the bottom of the inverted liquid reservoir. The pump assembly is attached to a screw cap that allows it to be easily assembled to a corresponding neck on the fluid reservoir.

The invention is able to adapt to existing traditional, mechanical dispersing pump designs but provide an improvement for certain applications by substituting the ball valve and adding a magnetic means for holding the ball valve closed. It may also eliminate the need for an internal spring. When an internal spring is eliminated, the pump is well-suited for activation by an external means such as a motor driven mechanism which both opens and closes the pump. The external means may operate at very low forces since there is no spring pressure to overcome. Consequently the design is suited for use with a motor driven mechanism, and is suited for a mechanism that is controlled by an electronic circuit under microprocessor control.

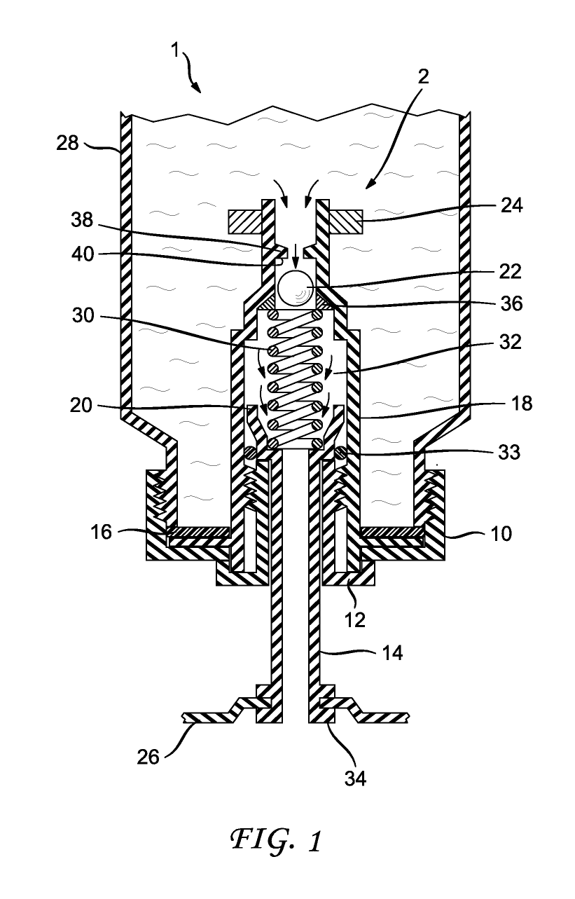

FIG. 1 is a cross-sectional view of pump/reservoir system 1 including invertable pump 2. Invertable pump 2 is shown in FIG. 1 in a recharging state, as will be discussed in greater detail below in the description of the operation of invertable pump 2. Reservoir 28 may enclose a liquid, which may be soap, water, oils, lubricants, or a liquid of varying viscosity, a foam, and/or a powder. Reservoir 28 may be a closed reservoir, may be open, or may be selectively and/or partially open. Reservoir 28 may attach to cap 10, or vice versa, with screw threads. The junction between reservoir 28 and cap 10 may include gasket 16 to provide a seal to prevent the leakage of the fluid in reservoir 28. Cap 10 may be securely attached to piston body 18, and retainer 12 may be securely attached to one or both of cap 10 and piston body 18. For instance, retainer 12 may engage piston body 18 with snap threads that provide a secure and optionally irreversible attachment of retainer 12 to piston body 18.

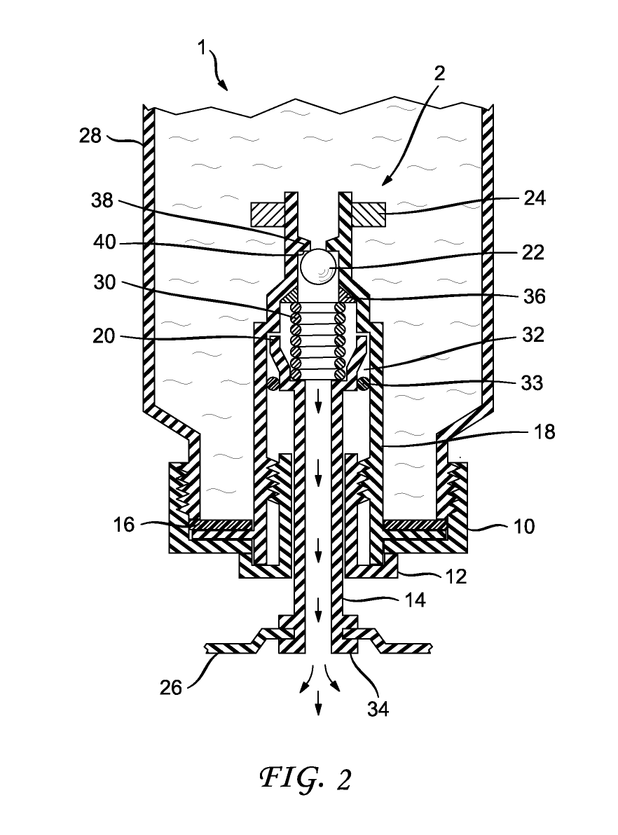

Piston 20 includes an end positioned in piston chamber 32 of piston body 20 and spout 14 extending to handle 26. Piston 20 is retained within retainer 12 by a close fit along a portion of the length of spout 14. The portion of piston 20 contained within piston chamber 32 also has a close fit with an interior wall of piston body 20. One or both of these close fits may be a friction fit, and may be substantially water tight. Additionally or alternatively, one or both of these close fits may also include a seal, for instance an “O” ring, as shown by seal 33. Piston 20 may be movable between an unactuated position (shown in FIG. 1) and an actuated position (shown in FIG. 2), and in particular may moved to the actuated position by manual control of handle 26. Alternatively, piston 20 may be actuated by a motor in response to an electronic control, for instance a proximity and/or movement sensor. Piston 20 may return to the unactuated position, after removal of the manual control of handle 26 or the cessation or reversal of motor control, under the power of spring 30. Spring 30 is positioned within piston chamber 32 in FIG. 1, but alternatively may be positioned on an exterior of piston chamber 32, or on the exterior of spout 14. In FIG. 1, spring 30 extends between piston 20 and ribs 36. Ribs 36 may provide a base or shelf for spring 30 to act against, and additionally may include a retention device to prevent the movement of spring 30. Alternatively, spring 30 may be positioned within piston chamber 32 such that in an unactuated position, sufficient pressure exists that spring 30 is compressed slightly from a maximum extension, with the slight compression providing a sufficient force to maintain spring 30 in a stable position.

Ball 22 cooperates with valve seat 40 of port 38 to selectively close and open port 38 to allow fluid to enter piston chamber 32 from reservoir 28. Ball 22 may be ferrous, or any other appropriate metal that is subject to being attracted or repelled by a magnet. Ball 22 may be coated with a metal or a metal coated with another material, for instance plastic. Ball 22 may alternatively be other than a spherical shape, and for instance may be a flap or hemisphere attached with a hinge or guided by rails, or any other appropriate shape. Magnet 24 may be positioned on piston body 18 on a side of port 38 away from piston chamber 32, so that magnet 24 attracts ball 22 to valve seat 40 to seal port 38. In alternative configurations, ball 22 may include magnetic material and magnet 24 may be a metal attractive to the magnet material of ball 22. In further alternatives, ball 22 may be magnetic and of an opposite polarity as magnet 24, so that there is an attractive force between ball 22 and magnet 24. Alternatively, port 38 itself may be composed of a magnetic material or a magnet as appropriate for attracting ball 22.

In still further alternatives, magnet 24 may be positioned within piston chamber 32, or at least on the same side of port 38 as piston chamber 32, and ball 22 may be restricted in movement so that it is always positioned between magnet 24 and port 38. In this alternative, ball 22 and magnet 24 should be configured to have a repulsive interaction, which may be accomplished by use of an appropriate polarity for magnet 24 with respect to a metal ball 22, or vice versa, or by using an opposite polarity magnet in ball 22 as in magnet 24. Further alternatives envision an electromagnet as magnet 24, which may be selectively operable to attract and/or repel ball 22, either in the position shown in FIG. 1, or in an alternative position within, around or on the edge of piston chamber 32. Magnet 24 may have any appropriate shape, including a block, a ring, a sphere, or a hemisphere, and may have various strengths for various purposes, and/or may have a variable strength in the case of an electromagnet.

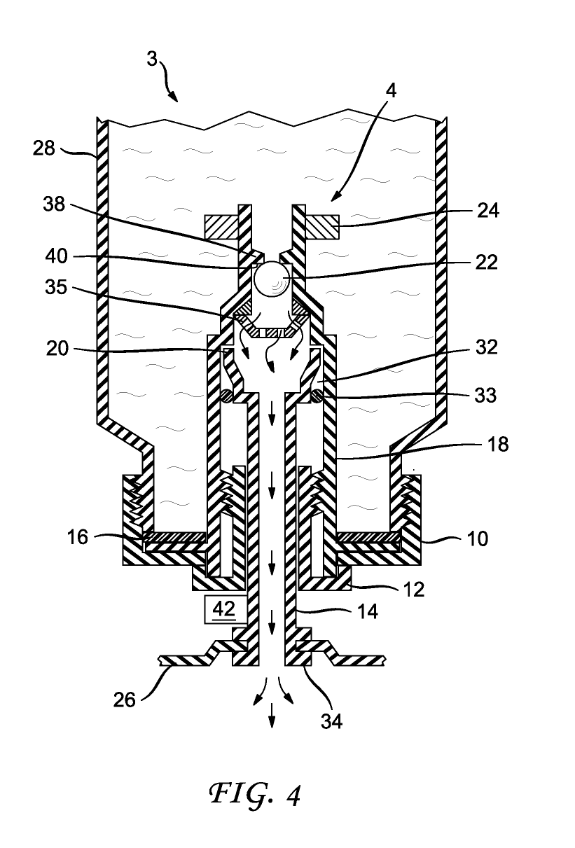

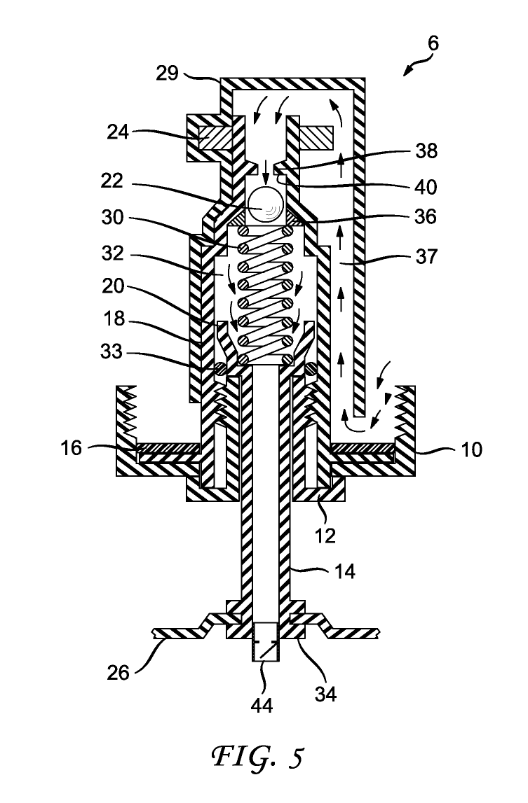

Ball 32 may be restricted in movement away from port 38 by projections on ribs 36, by an end portion of spring 30, or by any other appropriate method (for example ball retainer 35 shown in FIGS. 4 and 5).

FIG. 2 is a cross-sectional view of the first exemplary embodiment of the invertable pump shown in FIG. 1, in an actuated state. Operation of the first exemplary embodiment will be discussed in regard to FIG. 1 and FIG. 2. FIG. 1 illustrates a recharging of piston chamber 32 with fluid from reservoir 28 immediately following an actuation of piston 20 by handle 26. Fluid flows into piston chamber 32, as shown by the arrows in FIG. 2, due to a lower pressure in piston chamber 32 than reservoir 28. This pressure differential is sufficient to overcome the magnetic attraction between ball 22 and magnet 24, thereby causing ball 22 to move away from valve seat 40, thereby opening port 38. This pressure differential is caused by the expansion of piston chamber 32 in response to handle 26 moving from an actuated position, as shown in FIG. 2, to an unactuated position, as shown in FIG. 1. After piston chamber 32 fills with fluid from reservoir 28, the pressure in piston chamber 32 substantially equalizes with the pressure in reservoir 28, and the flow of fluid through port 38 slows or stops. When the flow of fluid through port 38 slows sufficiently that the force imparted by the flow is insufficient to overcome the magnetic attraction between ball 22 and magnet 24, ball 22 will seat on valve seat 40 and seal port 38 due to the magnetic attraction. Now pump/reservoir system 1 is ready to be used to discharge liquid.

FIG. 2 is reached from FIG. 1 by activating handle 26 by any of the methods described herein. As discussed above, piston chamber 32 is full of fluid from reservoir 28, the fluid in reservoir 28 and in piston chamber 32 are at substantially the same pressure, and ball 22 is seated on valve seat 40 sealing port 38 due to the attraction of ball 22 to magnet 24. Activating handle 26 in invertable pump 2 reduces the volume of piston chamber 32, and causes the fluid in piston chamber 32 to escape via the only open route, which is down spout 14 and out nozzle 34. The activation of handle 26, by increasing the pressure in piston chamber 32 creates a pressure differential between piston chamber 32 and reservoir 28. The result of this pressure differential is to cause ball 22 to seat more firmly on valve seat 40, thereby improving the seal of port 38. After the fluid flows out nozzle 34 in response to actuating handle 26, a user has obtained the desired effect of obtaining liquid from pump/reservoir system 1.

Releasing handle 26 allows spring 30 to force handle to move from the actuated position, shown in FIG. 2, to the unactuated position, shown in FIG. 1. This movement of handle 26 causes piston 20 to also move downward, thereby increasing the volume of piston chamber 32. The increased volume of piston chamber, with the reduced amount of fluid due to the ejection of fluid during the activation cycle out nozzle 34, leads to a reduced pressure in piston chamber 32. The reduced pressure in piston chamber 32 causes a pressure differential with respect to reservoir 28 which is sufficient to overcome the magnetic attraction between ball 22 and magnet 24. Liquid in spout 14 seals piston chamber 14 in this situation preventing air from being introduced into piston chamber 14. This works with a spout diameter small enough to produce capillary pressure sufficient to hold fluid in the spout/piston chamber.

If piston chamber 32 is not full of fluid in a start position, for instance during a first usage, one or more activations of handle 26 will fill piston chamber 32 in the manner described herein.

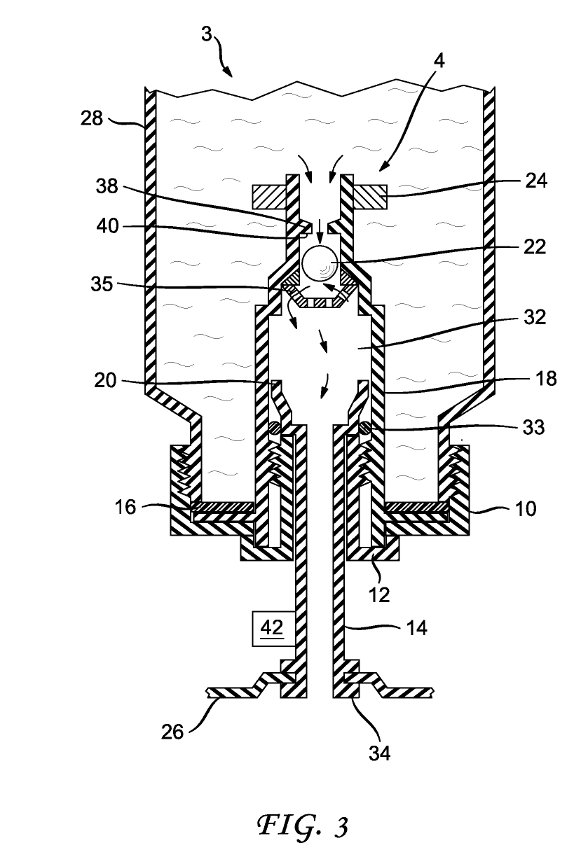

FIG. 3 is a cross-sectional view pump/reservoir system 3 including invertable pump 4. Invertable pump 4 is shown in FIG. 3 in a recharging state, and FIG. 4 is reached from FIG. 3 by activating handle 26 by any of the methods described herein. One distinctive feature of invertable pump 4 is that it does not include spring 30 for returning piston 20 to an unactuated position. In an embodiment, piston 20 may return to the unactuated position shown in FIG. 3 under the force of gravity. In an alternative embodiment, piston 20 may be moved by motor 42 which may operate against spout 14 or any other appropriate element rigidly or semi-rigidly connected to piston 20. Another distinctive feature of invertable pump 4 is that it includes ball retainer 35, which operates when ball 22 is unseated from valve seat 40, for instance when the piston is returning to an unactuated state and the fluid from reservoir 28 is flowing through port 38 to recharge piston chamber 32. Ball retainer 35 operates to prevent ball 22 from moving beyond a zone representing a significant field strength of magnet 24. In this manner, after recharging piston chamber 32 with fluid, ball 22 will be within range of attraction of magnet 24 and therefore able to create a seal of port 38 by seating on valve seat 40. Ball retainer 35 should therefore prevent the passage of ball 22, while not significantly inhibiting the passage of any fluid into piston chamber 32.

FIG. 4 is a cross-sectional view of invertable pump 4 shown in FIG. 3, in an actuated state. The operation of invertable pump 4 is substantially similar to the operation of invertable pump 2, with the exception of the return mechanism for piston 20 being either gravity or motor 42, and the retention of ball 22 due to ball retainer 35. The discharge of liquid out nozzle 34 due to activation of handle 26, the release of handle 36 causing a differential in pressure causing a recharge of piston chamber 32 with fluid from reservoir 28, and a resealing of port 38 by ball 22 under the influence of magnet 24 being substantially similar as described above in regard to invertable pump 2.

FIG. 5 is a cross-sectional view of invertable pump 6 in an unactuated and recharging state. Invertable pump 6 is substantially similar to invertable pump 2, with the additional feature of fluid diverter 29, which operates to draw fluid from a designated area of reservoir 28. In this manner, wastage may be reduced by drawing the fluid into port 38 from a low point of reservoir 28. Fluid flow 37 of fluid director 29 flows in a sealed manner from the low point of reservoir 28 to port 38, thereby reducing or eliminating the waste of fluid in reservoir 28 from the fluid level dropping below port 38. In an alternative configuration, fluid diverter 29 may include a flexible hose with a weighted end in which the hose has a sufficient length to reach all interior points of the reservoir. In this manner, invertable pump 6 may function in any orientation, and efficiently draw all liquid, foam or powder from the reservoir with minimal or no wastage. The weight at the end of this alternative fluid diverter 29 may be a weighted ball that encompasses the end of fluid diverter 29.

Invertable pump 6 includes spring 30 as in invertable pump 2, but does not include ribs 36. In invertable pump 6, spring 30 acts directly on ball 22 and therefore both the spring and the magnetic force of magnet 24 attracting ball 22 operate to close port 38 by ball 22 sitting on valve seat 40. Therefore, the spring coefficient of spring 30 and the strength of the magnetic attraction must be added to ensure that the pressure differential during a recharging cycle is sufficient to overcome the sum of these two forces.

Additionally or alternatively, and in particular with a larger diameter spout and/or a fluid having a low viscosity, valve 44 may be provided between piston chamber 32 and spout 14 to keep fluid in piston chamber 32. Any appropriate valve may be used, and in particular a rubber slit valve or a one-way spring valve may be provided. Valve 44 may provide an additional benefit in preventing air contamination of the fluid in piston chamber 32 during a period of disuse or limited use. The same concern of atmospheric conditions affecting product in spout 14 might apply to humidity-sensitive powder being distributed by an inverted pump according to the instant application. Valve 44 may be positioned near the end of spout 14 toward nozzle 34, or alternatively may be positioned in spout 14 at or near a junction with piston chamber 32. Positioning valve 44 toward nozzle 34 may more effectively enable valve 44 to prevent drainage of piston chamber 32, while positioning valve 44 closer to, or next to, piston chamber 32 may prevent drying in the spout of the fluid being delivered by the inverted pump, which may lead to clogging if left unused for an extended period.

A size of the pump and reservoir system according to the instant invention may be variable depending on the need addressed, and therefore the pump size may be vastly increased or miniaturized, as necessary.

The invertable pump described herein utilizes a ball or other configured valve to seal the port, however alternative configurations may also be possible that utilize the magnetic closure mechanism described herein. For example, a hinged flap may be utilized, or a hemisphere that is rotationally stabilized, for instance by a rod that projects through a center of the port and perpendicular to the opening.

While only a limited number of preferred embodiments of the present invention have been disclosed for purposes of illustration, it is obvious that many modifications and variations could be made thereto. It is intended to cover all of those modifications and variations which fall within the scope of the present invention, as defined by the following claims.

We claim:

1. A valve system for controlling a flow of a fluid, comprising:
a port including a valve seat;
a ball adapted to cooperate with the valve seat to seal the port; and
means for magnetically positioning the ball on the valve seat.

2. The valve system of claim 1, wherein:
the ball includes ferrous material; and
the means for magnetically positioning the ball on the valve seat includes a magnet arranged on a side of the port opposite the valve seat.

3. The valve system of claim 1, wherein:
the ball includes a magnetic material; and
the means for magnetically positioning the ball on the valve seat includes ferrous material arranged on a side of the port opposite the valve seat.

4. The valve system of claim 1, wherein:
the ball includes a magnetic material; and
the means for magnetically positioning the ball on the valve seat includes a magnet arranged on a side of the port opposite the valve seat;
wherein the magnetic material in the ball and the magnet have opposite polarities.

5. The valve system of claim 1, wherein:
the ball includes a magnetic material; and
the means for magnetically positioning the ball on the valve seat includes a magnet arranged on a same side of the port as the valve seat and the ball is restricted to a zone between the magnet and the valve seat;
wherein the magnetic material in the ball and the magnet have a same polarity.

6. The valve system of claim 1, wherein the means for magnetically positioning the ball on the valve seat includes an electromagnet selectively operable to:
attract the ball to the valve seat to seal the port when activated; and
allow the ball to move away from the valve seat to unseal the port when deactivated.

7. The valve system of claim 1, further comprising:
a piston body having the port on a first end and an outlet on a second end opposite the first end; and
a piston housed in the piston body and having an actuator handle adapted to move the piston toward the first end;
wherein, as the piston moves toward the first end, fluid in the piston body is forced out the outlet by a pressure differential between an interior of the piston body and an exterior region around the outlet.

8. The valve system of claim 7, wherein the ball is restricted to a zone around the valve seat by one of a retaining cage and an end of a spring arranged in the piston body.

9. The valve system of claim 7, wherein:
after the piston is moved toward the first end, and after a force applied to the actuator handle to move the piston toward the first end is removed, the piston moves toward the second end; and
a pressure differential between the fluid in the piston body and fluid in a reservoir situated on an opposite side of the port from the piston body causes fluid to flow from the reservoir to the piston body, causing the ball to move away from the valve seat.

10. The valve system of claim 9, wherein the piston moves toward the second end in response to one of:
gravity;
a spring arranged inside the piston body;
a spring arranged outside the piston body;
a motor moving the piston body;
a magnetic attraction between the piston and an element having a fixed position with respect to the piston body; and
a magnetic repulsion between the piston and the element having a fixed position with respect to the piston body.

11. The valve system of claim 9, further comprising a fluid diverter arranged on an opposite side of the port from the piston body, the fluid diverter causing fluid to flow from a selected position in the reservoir to the port.

12. A method for operating a pump, comprising:
actuating a piston to decrease an interior volume of a piston body forcing fluid in the piston body out an outlet by a first pressure differential between the interior volume and an exterior region around the outlet;
releasing the piston causing the piston to return to an unactuated position to increase the interior volume forcing fluid in a reservoir to move into the piston body through a port due to a second pressure differential between the interior volume and the reservoir; and
sealing the port with a ball after the piston returns to an unactuated position and the second pressure differential falls below a threshold by magnetically attracting the ball to a valve seat of the port.

13. The method of claim 12, further comprising restricting the ball to a zone around the valve seat by one of a retaining cage and an end of a spring arranged in the piston body.

14. The method of claim 12, wherein the piston returns to an unactuated position after being released under an influence of one of a spring, gravity, a motor, a magnetic attraction, and a magnetic repulsion.

15. The method of claim 12, further comprising:
providing a magnet on a side of the port opposite the valve seat;
wherein the ball includes ferrous material.

16. The method of claim 12, further comprising:
providing a ferrous material on a side of the port opposite the valve seat;
wherein the ball includes magnet material.

17. The method of claim 12, further comprising:
providing a magnet on a side of the port opposite the valve seat;
wherein the ball includes magnet material; and
wherein the magnetic material in the ball and the magnet have opposite polarities.

18. The method of claim 12, further comprising:
providing a magnet on a same side of the port as the valve seat; and
restricting the ball to a zone between the magnet and the valve seat;
wherein the ball includes magnet material; and
wherein the magnetic material in the ball and the magnet have a same polarity.

19. The method of claim 12, further comprising providing an electromagnet selectively operable to:
attract the ball to the valve seat to seal the port when activated; and
allow the ball to move away from the valve seat to unseal the port when deactivated.

20. The method of claim 12, further comprising diverting fluid from a selected position in the reservoir to an opposite side of the port from the piston body.

21. A valve system for controlling a flow of a fluid, comprising:
a port;
means for sealing the port; and
means for magnetically attracting the sealing means to the port.
